(19) United States
(12) Patent Application Publication
(10) Pub. No.: US 2013/0120529 A1
(43) Pub. Date: May 16, 2013

(54) VIDEO SIGNAL PROCESSING DEVICE AND VIDEO SIGNAL PROCESSING METHOD

(71) Applicants: Yutaka Nio, Osaka (JP); Haruko Terai, Osaka (JP); Daisuke Kase, Osaka (JP)

(72) Inventors: Yutaka Nio, Osaka (JP); Haruko Terai, Osaka (JP); Daisuke Kase, Osaka (JP)

(21) Appl. No.: 13/811,680

(22) PCT Filed: Jul. 28, 2011
(86) PCT No.: PCT/JP2011/004295

§ 371 Date: Jan. 23, 2013

(30) Foreign Application Priority Data
Jul. 28, 2010 (JP) 2010-168894

(51) Int. Cl. H04N 13/00

(52) U.S. Cl. CPC H04N 13/0029
USPC 348/43

(57) ABSTRACT

A video signal processing device includes: a stereo conversion unit which generates a stereo superimposed signal by performing stereo conversion processing on a superimposed signal obtained by superimposing, on a two-dimensional video signal, an additional information signal indicating additional information to be combined with a two-dimensional video and displayed, and shifts a first locating signal indicating a position of the additional information in the two-dimensional video, according to an amount of shift caused by the stereo conversion processing on the additional information signal, to generate a second locating signal indicating a position of the additional information in a video indicated by the stereo superimposed signal; and a correction unit performs, on the stereo superimposed signal, quality correction for an area other than an area located by the second locating signal.

### TECHNICAL FIELD

The present invention relates to a video signal processing device, and in particular to a video signal processing device which converts two-dimensional video signals into stereo video signals.

### BACKGROUND ART

Currently, most of video display devices typified by television receivers have a function to combine additional information typified by captions, subtitles, and on screen display (OSD), for instance, with video signals to be broadcast or video signals stored in a recording medium, and display the resultant signals.

In general, quality correction that is performed on a video is preferably not performed on additional information combined with the video as mentioned above. This is because such additional information indicates characters or still images obtained, for instance, using computer graphics (CG) in many cases, and thus if quality correction for correcting quality of an image of scenery or a person is performed on such additional information, a viewer is often given a sense of unnaturalness.

Here, Patent Literature (PTL) 1 discloses a video display device which includes a frame rate conversion processing unit which divides a video signal into an OSD portion and a non-OSD portion using position information of OSD when the OSD is generated, and then performs frame rate conversion processing.

Such processing by the video display device prevents frame interpolation from being performed on the OSD portion, and allows natural OSD display to be provided.

Furthermore, in recent years, technique of converting a 2D video into a stereo video (hereafter, also referred to as “3D video”) is disclosed as in PTL 2. Also, it is preferable not to perform quality correction on additional information such as OSD in a 3D video.

### CITATION LIST

### Patent Literature

[PTL 1] Japanese Unexamined Patent Application Publication No. 2009-265521
[PTL 2] Japanese Unexamined Patent Application Publication No. 2009-44722

### SUMMARY OF INVENTION

### Technical Problem

However, if the method disclosed in PTL 1 above is used so that quality correction for OSD is not performed on a 3D converted video as in PTL 2, the following problems occur.

When a 2D video is converted into a 3D video, a left-eye video image to which left-eye parallax has been added and a right-eye video image to which right-eye parallax has been added are generated from one 2D video image, first. At that time, parallax will be also given to OSD combined with the 2D video image as well.

Thus, even if processing of not performing quality correction on the OSD portion is to be executed using position information of the OSD at the point in time when the OSD is generated as in PTL 1, the position of the OSD will be changed due to the 3D conversion. Consequently, this leads to a situation where the position of the OSD cannot be located.

The present invention has been conceived in light of the above problems, and an object thereof is to provide a video signal processing device and a video signal processing method for allowing appropriate quality correction to be performed on a video obtained by 2D to 3D conversion.

### Solution to Problem

In order to solve the above conventional problems, a video signal processing device according to an aspect of the present invention includes a stereo conversion unit which performs stereo conversion processing including processing of generating a stereo video signal by shifting a two-dimensional video signal indicating a two-dimensional video, the stereo conversion unit being configured to (i) generate a stereo superimposed signal by performing the stereo conversion processing on a superimposed signal obtained by superimposing, on the two-dimensional video signal, an additional information signal indicating additional information to be combined with the two-dimensional video and displayed, and (ii) shift a first locating signal indicating a position of the additional information in the two-dimensional video, according to an amount of shift caused by the stereo conversion processing on the additional information signal, to generate a second locating signal indicating a position of the additional information in a video indicated by the stereo superimposed signal; and a correction unit configured to perform, on the stereo superimposed signal, quality correction for an area other than an area located by the second locating signal.

According to this configuration, the display area of additional information in a video obtained by 2D to 3D conversion is located by the second locating signal. Consequently, the correction unit can perform quality correction on a stereo superimposed signal indicating the video while avoiding quality correction on the display area of the additional information.

Specifically, according to the video signal processing device according to this aspect, appropriate quality correction can be performed on a video obtained by 2D to 3D conversion.

In addition, in the video signal processing device according to the aspect of the present invention, when the stereo conversion unit performs the stereo conversion processing on the superimposed signal, the stereo conversion unit may be configured to generate the stereo video signal from the two-dimensional video signal, shift the additional information signal to generate a stereo additional information signal indicating the additional information to be stereoscopically viewed, and generate the stereo superimposed signal which includes the stereo video signal and the stereo additional information signal.

According to this configuration, a stereo additional information signal indicating additional information to be stereoscopically viewed is generated. Specifically, an appropriate second locating signal is generated according to the amount of shift used in the generation process. Accordingly, for example, quality correction is performed appropriately on the whole stereo video which includes additional information, irrespective of the amount of recession or projection of additional information when the additional information is stereoscopically viewed.

In addition, in the video signal processing device according to the aspect of the present invention, a plurality of the first locating signals may be signals each indicating whether, when the two-dimensional video combined with the additional information is displayed, one of plural pixels constituting the two-dimensional video forms a part of the additional information.

According to this configuration, for example, the position of additional information in a two-dimensional video is detected accurately, and thus the accuracy of quality correction further improves.

In the video signal processing device according to the aspect of the present invention, in the stereo conversion processing by the stereo conversion unit, the stereo conversion unit may be configured to shift the two-dimensional video to generate the stereo video signal indicating a left-eye video obtained by adding left-eye parallax to the two-dimensional video and a right-eye video obtained by adding right-eye parallax to the two-dimensional video, and the stereo conversion unit may be configured to shift the additional information signal and the first locating signal according to one of the left-eye parallax and the right-eye parallax, to generate the stereo additional information signal and the second locating signal indicating a position of the additional information in a corresponding one of the left-eye video and the right-eye video, the additional information being indicated by the stereo additional information signal.

According to this configuration, stereo conversion processing is executed using parallax in stereoscopic vision, and also stereo-converted additional information (stereo additional information signal) and information indicating a position of the additional information after stereo conversion (second locating signal) are generated according to this parallax.

Accordingly, it is possible to display additional information which has been stereo-converted according to, for example, the stereoscopic appearance of scenery, a person, and the like other than additional information such as OSD, and also display a video in which appropriate quality correction has been performed on scenery and the like, and not on additional information.

In addition, a video signal processing device according to an aspect of the present invention may include a stereo conversion unit which performs stereo conversion processing including processing of generating a stereo video signal by shifting a two-dimensional video signal indicating a two-dimensional video, the stereo conversion unit being configured to generate a stereo superimposed signal by performing, on a superimposed signal obtained by superimposing on the two-dimensional video signal an additional information signal indicating additional information to be combined with the two-dimensional video and displayed, the stereo conversion processing for an area other than an area located by a first locating signal indicating a position of the additional information in the two-dimensional video; and a correction unit configured to perform, on the stereo superimposed signal, quality correction for the area other than the area located by the first locating signal.

According to this configuration, the video signal processing device according to this aspect does not stereo-convert additional information indicated by the superimposed signal, and thus quality correction can be performed on an area other than the display area of the additional information using the first locating signal as it is.

Specifically, the above configuration also achieves a video signal processing device which can perform appropriate quality correction on a video obtained by 2D to 3D conversion.

In addition, in the video signal processing device according to the aspect of the present invention, when the stereo conversion unit performs the stereo conversion processing on the superimposed signal, the stereo conversion unit may be configured to (i) generate the stereo video signal from the two-dimensional video signal, shift the additional information signal to generate a stereo additional information signal indicating the additional information to be stereoscopically viewed, and generate the stereo superimposed signal which includes the stereo video signal and the stereo additional information signal, and (ii) shift the first locating signal according to an amount of shift caused by shifting the additional information signal, to generate a second locating signal indicating a position of the additional information in a video indicated by the stereo superimposed signal, the video signal processing device may further comprise a change switch which outputs one of the first locating signal and the second locating signal to the correction unit in accordance with an inputted instruction, and the correction unit may be configured to perform, on the stereo superimposed signal, quality correction for an area other than an area located by the one of the first locating signal and the second locating signal outputted from the change switch.

According to this configuration, it is possible to select whether to stereoscopically or two-dimensionally display additional information such as OSD according to an instruction from a viewer, for example, and also perform quality correction on an area other than the display area of the additional information even when selection can be made therefrom.

The video signal processing method according to one aspect of the present invention can also be achieved as a video signal processing method which includes distinctive processing executed by the video signal processing device according to one of the above aspects.

In addition, the video signal processing method can be achieved as a program for causing a computer to execute the processes included in the video signal processing method, and also achieved as a recording medium having stored thereon the program. Further, the program can also be distributed via a transmission medium such as the Internet or a recording medium such as DVD.

### Advantageous Effects of Invention

According to the video signal processing device and the video signal processing method of the present invention, it is possible to locate a display area of additional information such as OSD superimposed on a stereo video, in a stereo superimposed signal which is a video signal obtained by 2D to 3D conversion. As a result, it is possible to perform quality correction on a stereo superimposed signal except the display area of additional information such as OSD. Specifically, appropriate quality correction can be performed on a video obtained by 2D to 3D conversion.

### BRIEF DESCRIPTION OF DRAWINGS

FIG. 1 is a block diagram illustrating a basic configuration of a video signal processing device according to Embodiment 1.

FIG. 2 illustrates images of when various superimposed signals are displayed on a screen in Embodiment 1.

FIG. 3 is a flowchart showing an example of a flow of video processing by the video signal processing device according to Embodiment 1.

FIG. 4 is a flowchart showing an example of a flow of second locating signal generation processing by the video signal processing device according to Embodiment 1.

FIG. 5 is a flowchart showing an example of a flow of signal correction processing by the video signal processing device according to Embodiment 1.

FIG. 6 is a block diagram illustrating a basic configuration of a video signal processing device according to Embodiment 2.

FIG. 7 is a flowchart showing an example of a flow of video processing by the video signal processing device according to Embodiment 2.

FIG. 8 is a flowchart showing an example of a flow of stereo superimposed signal generation processing by the video signal processing device according to Embodiment 2.

FIG. 9 illustrates images of when various superimposed signals are displayed on a screen in Embodiment 2.

FIG. 10 is a flowchart showing an example of a flow of signal correction processing by the video signal processing device according to Embodiment 2.

FIG. 11 is a block diagram illustrating a basic configuration of a video signal processing device according to a first variation of Embodiment 2.

FIG. 12 is a flowchart showing an example of a flow of video signal processing according to a second variation of Embodiment 2.

FIG. 13 is a block diagram illustrating a basic configuration of a video signal processing device according to the second variation of Embodiment 2.

### DESCRIPTION OF EMBODIMENTS

The following is a description of embodiments of the present invention with reference to the drawings. The embodiments described below each show a preferred specific example of the present invention. Constituent elements, details of processing performed by the constituent elements, the arrangement and connection of the constituent elements, steps, the processing order of the steps, and the like described in the following embodiments are mere examples, and thus are not intended to limit the scope of the appended claims.

The present invention is defined only by the scope of the claims. Therefore, among the constituent elements in the following embodiments, constituent elements not recited in the independent claims which show the broadest concept of the present invention are not necessarily needed to achieve an object of the present invention, but described as elements which form more preferred embodiments.

### Embodiment 1

The following is a description of Embodiment 1 with reference to the drawings.

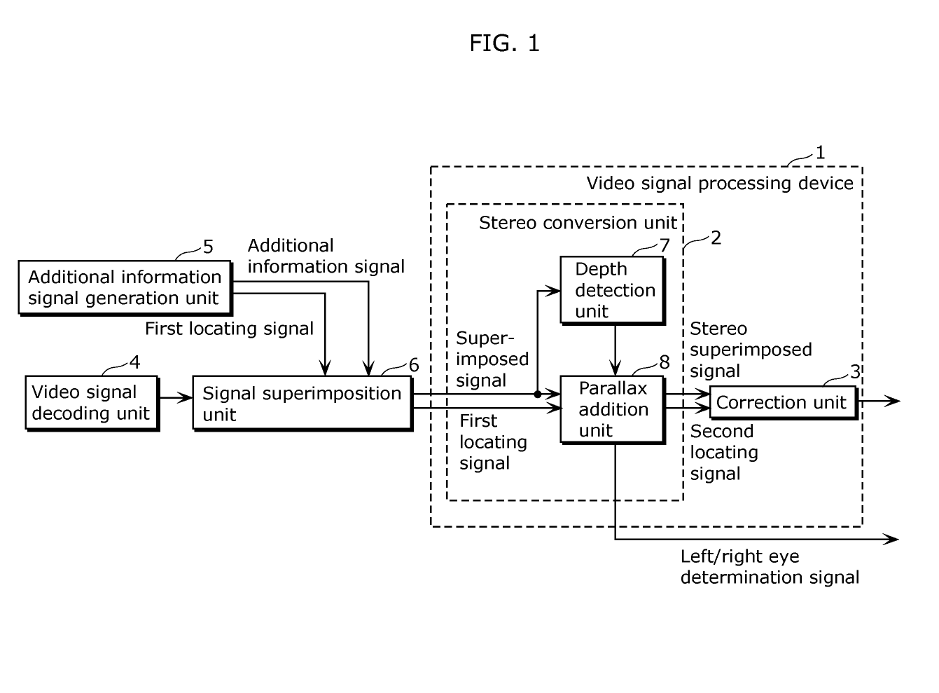

FIG. 1 is a block diagram illustrating a basic configuration of a video signal processing device 1 according to Embodiment 1. The following is a description of a configuration of the video signal processing device 1 according to Embodiment 1.

### <Description of Device>

The video signal processing device 1 is a device which receives two-dimensional video signals, additional information signals, and first locating signals, generates stereo superimposed signals using these signals, and furthermore performs quality correction.

The video signal processing device 1 includes a stereo conversion unit 2 and a correction unit 3.

Two-dimensional video signals are signals generated by a video signal decoding unit 4 decoding broadcast signals or signals read from a recording medium, and are signals indicating a two-dimensional flat video (two-dimensional video).

Additional information indicated by additional information signals is information to be combined with a two-dimensional video and displayed. For example, additional information is information such as menu information, channel information, data broadcasting information, and subtitle information, and typically is information called OSD.

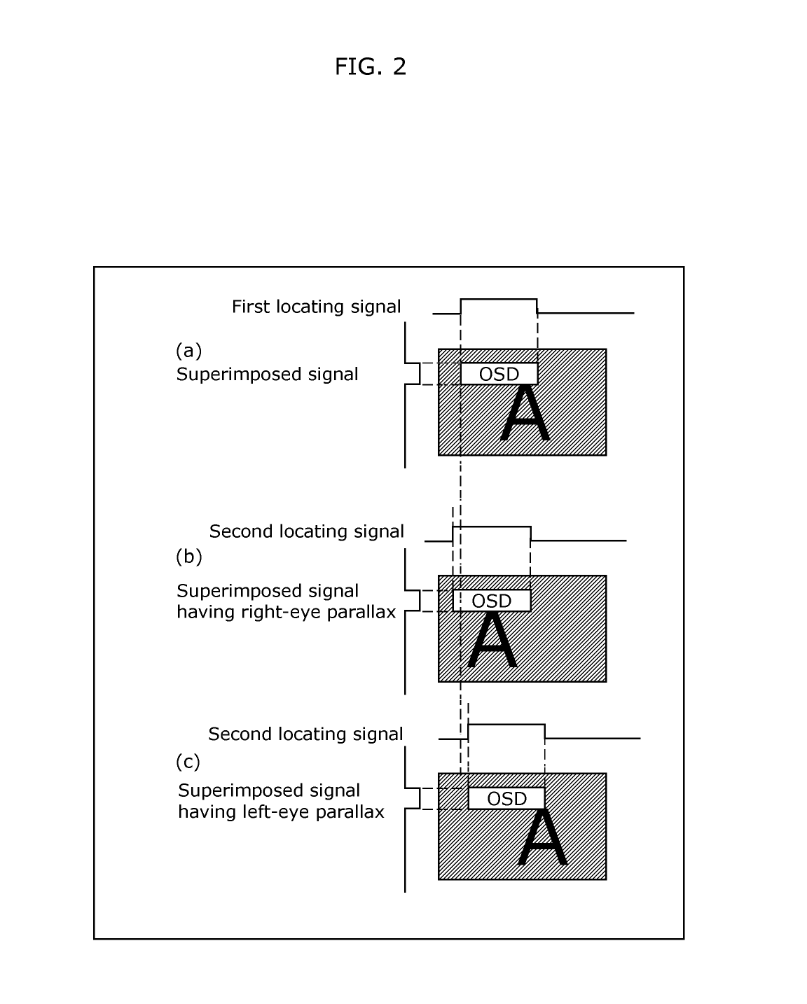

The video signal processing device 1 receives first locating signals, and generates second locating signals from the first locating signals. First locating signals are signal indicating a position of additional information in a two-dimensional video when the additional information is combined with the two-dimensional video and displayed. A description is given of such first locating signals, with reference to FIG. 2.

FIG. 2 illustrates images of when various superimposed signals are displayed on a screen in Embodiment 1.

It should be noted that first locating signals are conceptually shown in the images. Part (a) of FIG. 2 illustrates an image of when superimposed signals obtained by combining a two-dimensional video and additional information which is OSD information are displayed on the screen.

Here, the first locating signals shown in (a) of FIG. 2 are focused on. Each first locating signal is expressed by a horizontal signal and a vertical signal.

It should be noted that the horizontal signal and the vertical signal are examples of signals each indicating whether, when a two-dimensional video combined with additional information is displayed, one of plural pixels constituting the two-dimensional video forms a part of the additional information.

In the examples shown in FIG. 2, information is formed in which when additional information signals are combined with a two-dimensional video and displayed on the screen, the reversal of polarity of first locating signals in the section where OSD is displayed indicates the display position of the additional information which is displayed based on the additional information signals.

An additional information signal generation unit 5 generates first locating signals and additional information signals. For example, when a viewer controls the volume using a remote control or a switch, the additional information signal generation unit 5 generates, as OSD, a symbol, a graphic, or the like to be displayed on a screen to show the volume level, and outputs the generated OSD as additional information signals.

Furthermore, in this case, the additional information signal generation unit 5 outputs first locating signals which are signals indicating the display position of a symbol, a graphic, or the like to be displayed on the screen, to show the volume level.

A signal superimposition unit 6 combines two-dimensional video signals and the additional information signals, based on the first locating signals, and generates superimposed signals. Specifically, the signal superimposition unit 6 generates superimposed signals obtained by superimposing the additional information signals on the two-dimensional video signals so that the combined additional information is displayed at the position indicated by the first locating signals in the two-dimensional video.

Two-dimensional video signals which are signals generated by the video signal decoding unit 4 decoding broadcast signals or video signals stored on a recording medium, for example, and additional information signals indicating additional information such as an OSD image are inputted to the signal superimposition unit 6. The signal superimposition unit 6 superimposes the additional information signals on the two-dimensional video signals, and outputs the resultant signals.

The signal superimposition unit 6 superimposes OSD such as a symbol or a graphic for showing the volume level on broadcast signals that are being received, for example. Then, the signal superimposition unit 6 outputs the superimposed signals generated by superimposing these signals.

The stereo conversion unit 2 has a depth detection unit 7 and a parallax addition unit 8. The depth detection unit 7 analyzes a two-dimensional flat video (two-dimensional video) indicated by inputted superimposed signals, and detects how much depth is to be given to each pixel of pictures in a video. Specifically, the depth detection unit 7 detects the amount of depth for each pixel.

Giving depth to a pixel means setting left-eye parallax or right-eye parallax in each pixel. The parallax addition unit 8 performs processing such as horizontal shift on each pixel, based on the amount of depth detected by the depth detection unit 7. A detailed description is given of this shift processing, with reference to FIG. 2.

Parts (b) and (c) of FIG. 2 illustrate examples of screen display when right-eye parallax and left-eye parallax are added to the superimposed signals shown in (a) of FIG. 2.

When focusing on the character “A” on the screen, it can be seen that the character “A” shifts to the left due to right-eye parallax, and shifts to the right due to left-eye parallax. Video images to which right-eye parallax and left-eye parallax are respectively given as described above are viewed through dedicated glasses, and thereby the character “A” is three-dimensionally perceived. In other words, “A” is stereoscopically viewed.

The correction unit 3 performs signal correction for the purpose of quality correction on an inputted signal, for instance. The correction unit 3 performs peaking processing, γ (gamma) correction, contrast correction, and the like, for example.

### <Operation of Device>

The following is a description of operation of the video signal processing device 1.

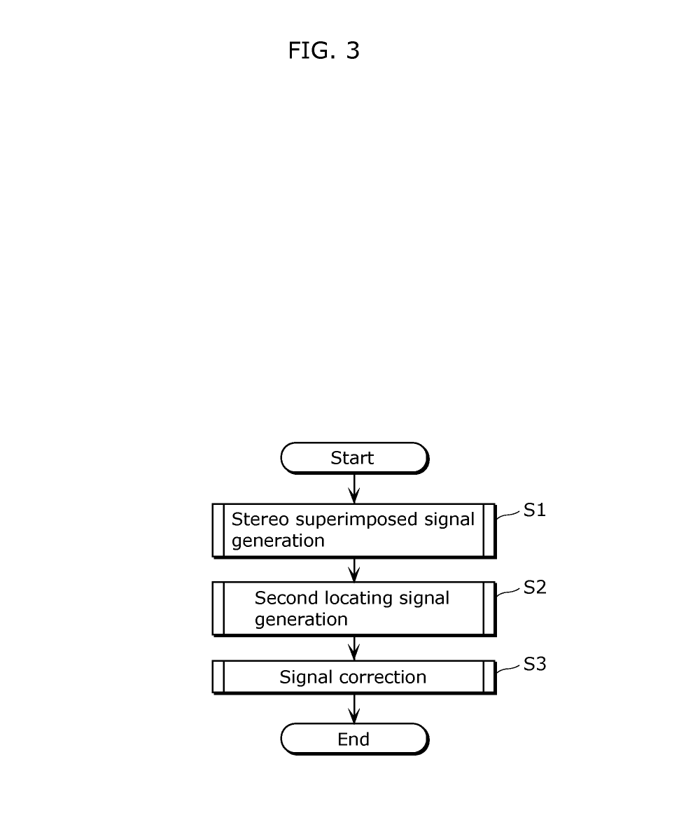

FIG. 3 is a flowchart showing an example of a flow of video processing by the video signal processing device 1 according to Embodiment 1. A description is given of the operation of the video signal processing device 1 using FIG. 3, with reference to FIG. 1 as necessary.

Video processing by the video signal processing device 1 includes a stereo superimposed signal generation step (S1), a second locating signal generation step (S2), and a signal correction step (S3).

First is a description of the stereo superimposed signal generation step (S1). In the stereo superimposed signal generation step, the stereo conversion unit 2 stereo-converts superimposed signals obtained by superimposing additional information signals on two-dimensional video signals, thereby generating stereo superimposed signals.

Specifically, two-dimensional video signals decoded by the video signal decoding unit 4 and additional information signals generated by the additional information signal generation unit 5 are inputted to the signal superimposition unit 6. Furthermore, the additional information signal generation unit 5 generates first locating signals corresponding to the additional information signals previously generated, and transfers the generated signals to the signal superimposition unit 6.

The signal superimposition unit 6 superimposes the additional information signals on the two-dimensional video signals using these signals, thereby generating superimposed signals.

Next, the depth detection unit 7 obtains the superimposed signals, and detects the amounts of depth of pixels corresponding to the superimposed signals. The depth detection unit 7 transfers the detected amounts of depth to the parallax addition unit 8. In accordance with the detected amounts of depth, the parallax addition unit 8 converts the superimposed signals into stereo superimposed signals including right-eye signals obtained by adding right-eye parallax to the superimposed signals and left-eye signals obtained by adding left-eye parallax to the superimposed signals.

Specifically, in the present embodiment, stereo superimposed signals which include stereo video signals corresponding to the two-dimensional video and stereo additional information signals indicating the additional information to be stereoscopically viewed are generated through the stereo conversion processing.

In addition, the parallax addition unit 8 outputs left/right eye determination signals to the outside in order to achieve synchronization between a 3D video (stereo video) and operation of dedicated glasses, concurrently with the above processing.

In this way, the stereo conversion unit 2 shifts two-dimensional video signals indicating a two-dimensional video, thereby performing stereo conversion processing which includes processing of generating stereo video signals.

Next is a description of the second locating signal generation step (S2). As a preparation for the second locating signal step, the additional information signal generation unit 5 generates first locating signals corresponding to the additional information signals previously generated, and transfers the generated signals to the signal superimposition unit 6 in the stereo superimposed signal generation step (S1) described above. Furthermore, the first locating signals inputted to the signal superimposition unit 6 are transferred to the parallax addition unit 8.

It should be noted that with regard to the preparation processing here, it is important that first locating signals are transferred to the parallax addition unit 8, and thus a transfer path of the first locating signals can be changed as appropriate.

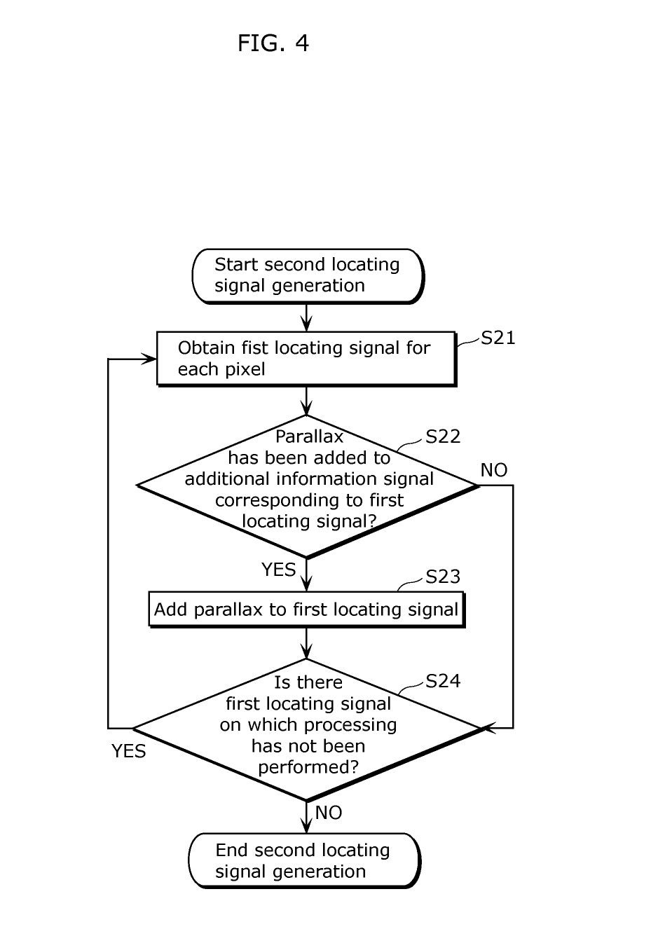

A detailed description is given of processing after the parallax addition unit 8 receives first locating signals, with reference to FIG. 4.

FIG. 4 is a flowchart showing an example of a flow of second locating signal generation processing by the video signal processing device 1 according to Embodiment 1.

First, the parallax addition unit 8 obtains a first locating signal, for each pixel (S21).

Next, the parallax addition unit 8 checks, for each pixel, whether parallax has been added to an additional information signal corresponding to the obtained first locating signal for the pixel (S22). Then, if parallax has been added (YES in S22), parallax is also added to the first locating signal as well (S23).

Specifically, as illustrated in (b) of FIG. 2, if parallax is added leftward to the pixel in a right-eye video, the parallax addition unit 8 also shifts leftward the first locating signal corresponding to the pixel.

In this manner, second locating signals (more specifically, right-eye locating signals and left-eye locating signals) are generated.

Here, there are various conceivable methods as the checking method in S22. An example of simple processing is to check whether parallax has been added to a pixel determined, using a first locating signal, as being a pixel which displays OSD or the like in the stereo superimposed signal generation step.

In addition, more preferably, it is conceivable to synchronize times at which a superimposed signal is read and written and times at which a first locating signal is read and written when the parallax addition unit 8 adds parallax.

The above synchronous processing may be performed only on a pixel determined, using a first locating signal, to be used for displaying additional information.

In this manner, processing is performed successively, and when there is no first locating signal on which processing has not been performed (NO in S24), all the first locating signals corresponding to additional information signals to which parallax has been added are converted into second locating signals including right-eye locating signals and left-eye locating signals.

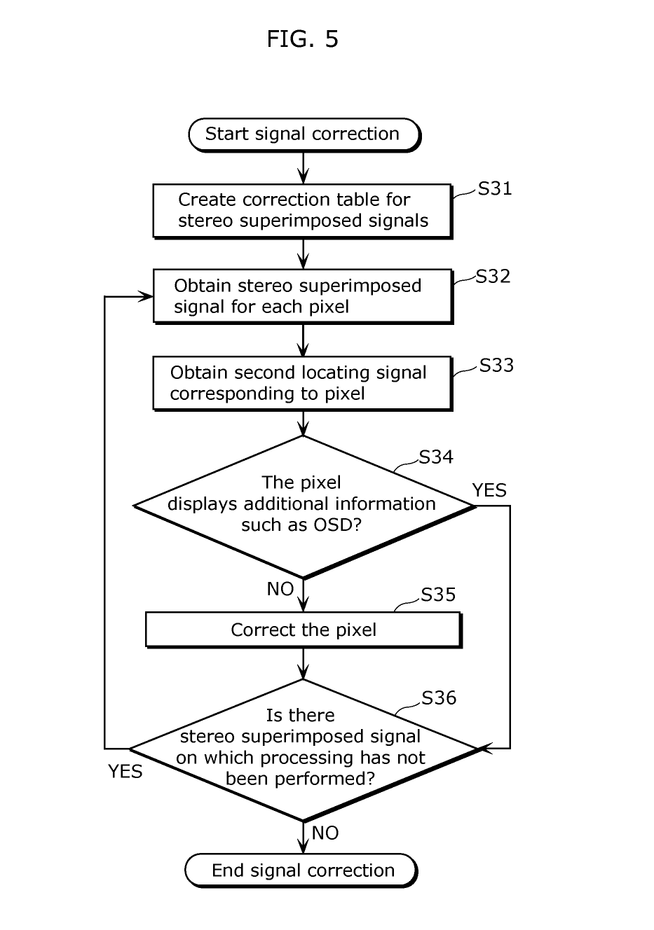

Next is a description of the signal correction step (S3). In the signal correction step (S3), quality correction for an area other than an area located by second locating signals is performed on stereo superimposed signals. A detailed description is given of the signal correction step (S3), using FIG. 5.

FIG. 5 is a flowchart showing an example of a flow of signal correction processing by the video signal processing device 1 according to Embodiment 1.

First, the correction unit 3 creates a correction table for stereo superimposed signals (S31). A correction table is a table for converting quality parameters in consideration of the relationship of pixels when displaying stereo superimposed signals on a screen, for instance.

Next, the correction unit 3 obtains a stereo superimposed signal for each pixel (S32), and obtains a second locating signal corresponding to the pixel for which the signal has been obtained (S33). Then, the correction unit 3 determines, using the second locating signal, whether the pixel is a pixel which displays OSD or the like (S34). If the pixel for which the signal has been obtained is not a pixel which displays OSD or the like (NO in S34), the correction unit 3 performs quality correction on the pixel in accordance with the correction table (S35). If the pixel for which the signal has been obtained is a pixel which displays OSD or the like (YES in S34), the correction unit 3 does not perform quality correction on the pixel.

This processing is repeated until there is no stereo superimposed signal on which processing has not been performed (S36), and processing ends when there is no such stereo superimposed signal (NO in S36). Quality correction is not performed on an area in which additional information such as OSD is displayed, in a video obtained from stereo superimposed signals through such processing.

It should be noted that the correction unit 3 may not need to perform quality correction on the entire area other than an area in which additional information is displayed. For example, quality correction may be performed only on some pixels selected by comparing pixel values of pixels in an area other than a display area of additional information with a predetermined threshold value.

### Summary of Embodiment 1

Examples of advantageous effects of the present embodiment are as follows.

According to a conventional technique, if a superimposed signal is stereo-converted, superimposed additional information such as OSD is also stereo-converted, and the display position of the additional information also shifts. Accordingly, although there has been an attempt to avoid quality correction only on the display area of the additional information, selectively, it results in a failure.

In contrast, according to the present invention, the stereo conversion unit 2 also corrects first locating signals indicating the position of additional information such as OSD, in accordance with stereo conversion processing on two-dimensional video signals, thereby generating second locating signals as new position information.

The video signal processing device 1 according to the present embodiment can locate, by using such second locating signals, the position of additional information such as OSD on the display, which is superimposed on stereo superimposed signals obtained by stereo conversion. As a result, it is possible to perform quality correction on stereo superimposed signals, except the display area of the additional information such as OSD.

The following advantages are achieved by performing quality correction on stereo superimposed signals except the display area of additional information such as OSD in this manner.

Specifically, originally, the quality correction function of the correction unit 3 is important for natural images such as a background and a person, to improve expressiveness thereof. However, if similar processing is performed on an artificially composed image such as OSD or a subtitle, this results in an unnatural video and gives a viewer a sense of unnaturalness, rather than improving expressiveness thereof.

Furthermore, it is known that viewers are highly sensitive to a stereo video. As a result, an advantage that viewers do not feel a sense of unnaturalness by not performing quality correction on an image showing additional information such as OSD leads to a great effect in light of health and mind, in addition to improvement in the quality of a video outputted from the video signal processing device 1 as a whole.

It should be noted that although signals for locating the display area of additional information in the horizontal and vertical directions are used as first locating signals in the present embodiment, the present invention is not limited to this.

Various signals are applicable as first locating signals applied to the present invention. For example, alpha blending signals indicating the transparency of additional information such as OSD when the additional information is combined may be used as the first locating signals.

A configuration may be adopted in which a first locating signal is generated for each pixel. Specifically, as long as the position of additional information at the time when the additional information is combined with a two-dimensional video and displayed can be located, any signal may be used.

Here, in the present embodiment, FIG. 2 illustrates first locating signals for locating the display position of additional information in the vertical direction, in addition to first locating signals corresponding to the horizontal direction, in order to facilitate the understanding of characteristics of the first locating signals. However, the first locating signals corresponding to the vertical direction are not necessarily needed.

In other words, if pixels move only in the horizontal direction due to the addition of parallax for stereoscopic display to a two-dimensional video, second locating signals may be generated by using first locating signals for locating the display position of additional information in the horizontal direction without using first locating signals corresponding to the vertical direction.

It should be noted that in the present embodiment, stereo superimposed signals which include stereo video signals and stereo additional information signals are generated through the above stereo conversion process, as described above. However, it is sufficient for the stereo conversion unit 2 to generate at least stereo video signals, and the stereo conversion unit 2 does not necessarily need to perform processing on additional information to allow the information to be stereoscopically viewed.

In this case, the stereo conversion unit 2 may simply generate second locating signals by shifting inputted first locating signals, according to the amount of shift “0” in the stereo conversion processing on additional information signals. Specifically, in this case, conversion processing is not substantially performed on first locating signals, and the signals are outputted as second locating signals.

In addition, even in the case where additional information is not stereo-converted in this manner, the display area of the additional information is located by second locating signals notified to the correction unit 3. Accordingly, the correction unit 3 can perform quality correction on an area other than the display area of the additional information.

It should be noted that Embodiment 2 below also describes a video signal processing device which generates stereo superimposed signals which include additional information signals that are not stereo-converted.

### Embodiment 2

The following is a description of Embodiment 2, with reference to the drawings.

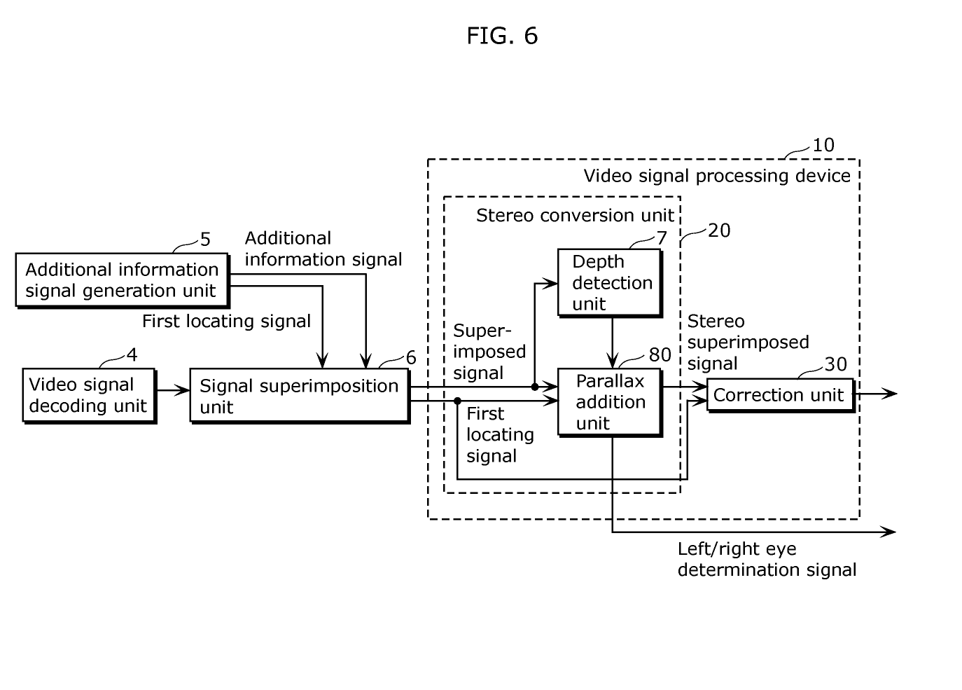

FIG. 6 is a block diagram illustrating a basic configuration of a video signal processing device 10 according to Embodiment 2. The following is a description of a configuration of the video signal processing device 10 according to Embodiment 2.

### <Description of Device>

Differences between the device configuration according to Embodiment 2 illustrated in FIG. 6 and the device configuration (see FIG. 1) according to Embodiment 1 are the video signal processing device 10, a stereo conversion unit 20, and a correction unit 30.

In Embodiment 2, using the device and the units, additional information such as OSD is not stereo-converted, and quality correction is performed on stereo superimposed signals, except a display area of OSD, for instance, using existing first locating signals. It should be noted that other elements are the same as those in Embodiment 1 unless description is specifically given, and thus a description thereof is omitted.

The video signal processing device 10 is a device which receives two-dimensional video signals, additional information signals, and first locating signals, converts the signals into stereo superimposed signals, and further performs quality correction. The video signal processing device 10 includes the stereo conversion unit 20 and the correction unit 30.

Here, differences between the video signal processing device 10 according to Embodiment 2 and the video signal processing device 1 according to Embodiment 1 are the flow of a signal in the stereo conversion unit 20, the configuration of a stereo superimposed signal outputted from the stereo conversion unit 20, and a type of signal received by the correction unit 30.

The stereo conversion unit 20 performs stereo conversion processing for an area other than the area located by first locating signals on superimposed signals obtained by superimposing additional information signals on two-dimensional video signals, thereby generating stereo superimposed signals.

Specifically, the stereo conversion unit 20 has a depth detection unit 7 and a parallax addition unit 80. The parallax addition unit 80 performs processing such as horizontal shift on each pixel, based on the amount of depth detected by the depth detection unit 7, as with the parallax addition unit 8 in Embodiment 1. However, the operation algorithm of the parallax addition unit 80 is different from that of the parallax addition unit 8. This will be described below.

The correction unit 30 performs signal correction on inputted signals, as with the correction unit 3 in Embodiment 1. Although the correction unit 30 performs, for example, peaking processing, γ correction, contrast correction, or the like, signals received thereby differ from signals received by the correction unit 3.

Specifically, the correction unit 3 operates upon reception of second locating signals and stereo superimposed signals which include stereo-converted two-dimensional video signals and stereo-converted additional information signals. However, the correction unit 30 operates upon reception of first locating signals and stereo superimposed signals which include converted two-dimensional video signals and additional information which has not been stereo-converted.

### <Operation of Device>

The following is a description of operation of the video signal processing device 10.

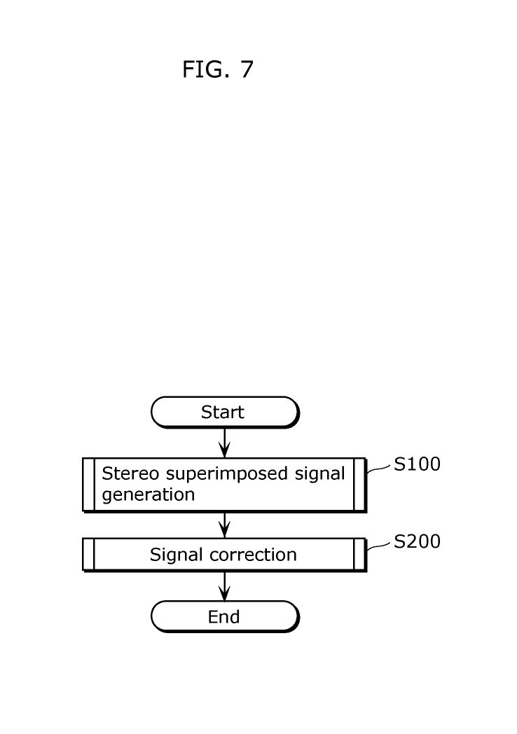

FIG. 7 is a flowchart showing an example of a flow of video processing by the video signal processing device 10 according to Embodiment 2. A description is given of the operation of the video signal processing device 10 using FIG. 7, with reference to FIG. 6 as necessary.

Video processing by the video signal processing device 10 includes a stereo superimposed signal generation step (S100) and a signal correction step (S200).

A description is given of the stereo superimposed signal generation step (S100). In the stereo superimposed signal generation step, the stereo conversion unit 20 generates stereo superimposed signals by stereo-converting superimposed signals obtained by superimposing additional information signals on two-dimensional video signals, using first locating signals.

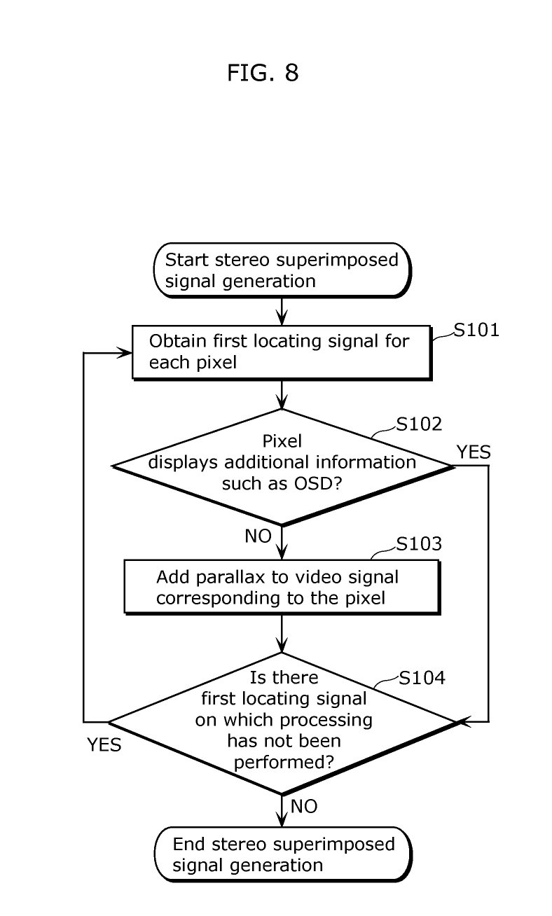

Specifically, the stereo conversion unit 20 receives superimposed signals, and the depth detection unit 7 detects the amounts of depth from the superimposed signals, and transfers the detected amounts of depth to the parallax addition unit 80. The processing up to here is the same as that of processing by the stereo conversion unit 2 in Embodiment 1. A description is given of the flow thereafter using FIG. 8.

FIG. 8 is a flowchart showing an example of a flow of stereo superimposed signal generation processing by the video signal processing device 10 according to Embodiment 2.

The parallax addition unit 80 obtains a first locating signal for each pixel (S101). Then, the parallax addition unit 80 determines from the first locating signal whether a pixel corresponding to the obtained first locating signal displays additional information such as OSD (S102). If the pixel corresponding to the obtained first locating signal displays additional information such as OSD (YES in S102), the parallax addition unit 80 does not add parallax to this pixel.

Specifically, a signal indicating additional information such as OSD among superimposed signals is not stereo-converted. Thus, additional information signals are not shifted (right-eye parallax or left-eye parallax is not added thereto), and as a result, the position of the display area of the additional information is the same in a right-eye video and a left-eye video.

If the pixel corresponding to the obtained first locating signal does not display information such as OSD (NO in S102), the parallax addition unit 80 performs stereo conversion by adding parallax to this pixel (S103).

In this manner, when there is no first locating signal on which processing has not been performed (NO in S104), processing of generating stereo superimposed signals ends.

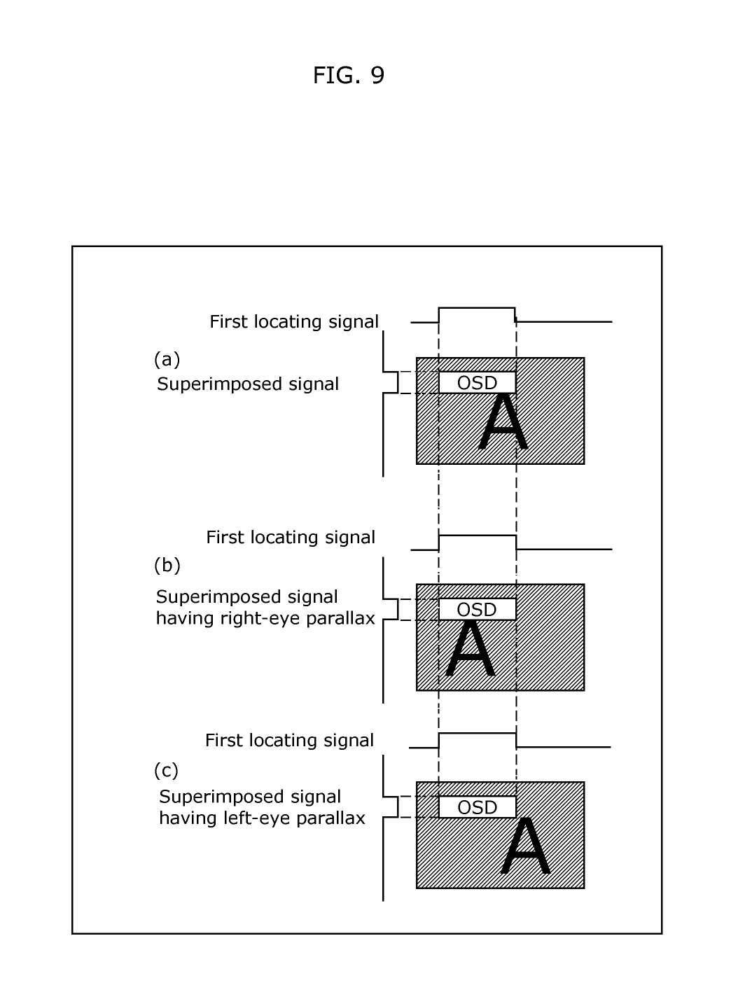

A detailed description is further given of stereo superimposed signals in Embodiment 2, using FIG. 9.

FIG. 9 illustrates images of when various superimposed signals are displayed on a screen in Embodiment 2. Part (a) of FIG. 9 illustrates an image of when superimposed signals obtained by combining two-dimensional video signals and additional information signals indicating OSD information are displayed on the screen, and is the same as that of (a) of FIG. 2.

Here, the following can be seen by comparison between (b) of FIG. 2 and (b) of FIG. 9 illustrating an image of when superimposed signals having right-eye parallax are displayed on the screen, and between (c) of FIG. 2 and (c) of FIG. 9 illustrating an image of when superimposed signals having left-eye parallax are displayed on the screen, the signals constituting stereo superimposed signals obtained by stereo conversion.

Specifically, it can be seen that video signals indicating the character “A” in FIG. 9 have been stereo-converted, or in other words, parallax has been added as with “A” in FIG. 2, whereas parallax is not added to OSD in FIG. 9.

This shows a result of stereo conversion on superimposed signals using first locating signals, except an area located by the first locating signals in stereo superimposed signal generation processing in Embodiment 2 described above.

If such processing is executed, additional information such as OSD does not have stereoscopic effect unlike Embodiment 1, even if a video obtained from stereo superimposed signals is viewed using dedicated glasses.

The correction unit 30 performs signal correction on stereo superimposed signals generated in this way.

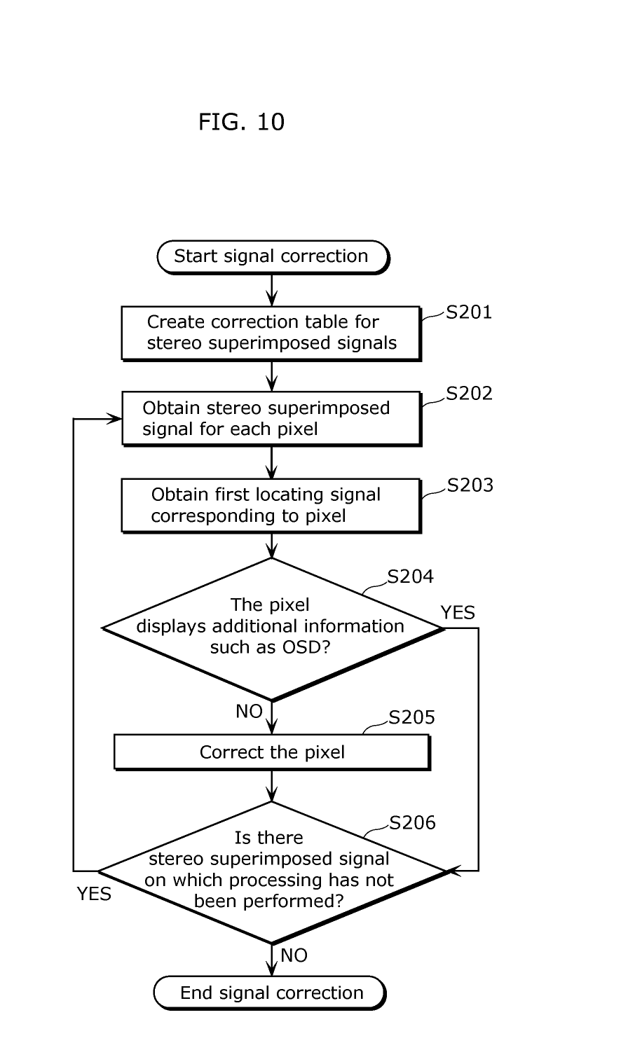

FIG. 10 is a flowchart showing an example of a flow of signal correction processing by the video signal processing device 10 according to Embodiment 2.

The flow of signal correction processing according to Embodiment 2 is similar to signal correction processing according to Embodiment 1 (see FIG. 5). Specifically, steps S201, S202, S203, S204, S205, and S206 in FIG. 10 correspond to steps S31, S32, S33, S34, S35, and S36 in FIG. 5, respectively.

However, in signal correction processing in Embodiment 2, which pixels are to be subjected to quality correction is determined using first locating signals (S203, S204), rather than second locating signals (S33, S34 in FIG. 5), unlike signal correction processing in Embodiment 1.

The cause of this difference is that since parallax is not added to additional information signals indicating additional information such as OSD in stereo superimposed signals in Embodiment 2, whether quality correction is necessary may be determined using first locating signals to which parallax is not added, as well.

Such processing prevents quality correction from being performed on a display area of additional information such as OSD in a video obtained from stereo superimposed signals.

### Summary of Embodiment 2

Examples of advantageous effects of the present embodiment are as follows.

First, the present embodiment has an effect of not performing quality correction on an area in which additional information such as OSD is displayed, as with Embodiment 1. Thus, the present embodiment brings an advantage of not giving a viewer a sense of unnaturalness, and the advantage leads to a great effect in light of health and mind, in addition to improvement in the quality of a video outputted from the video signal processing device 10 as a whole, as well as in Embodiment 1.

Furthermore, an example of a feature of the video signal processing device 10 according to the present embodiment is that the additional information such as OSD is not stereo-converted. It is possible to give a viewer various visual effects by stereo-converting additional information such as OSD. However, it is often difficult to set an appropriate value indicating how much depth is to be given when stereo conversion is performed.

Accordingly, one way to solve such a problem is not to uniformly stereo-convert additional information such as OSD.

In view of this, in the present embodiment, superimposed signals are stereo-converted using first locating signals, except an area located by the first locating signals. Accordingly, not only additional information such as OSD is not stereoscopically displayed, but also first locating signals can be used for quality correction without being converted, which differs from Embodiment 1.

In this way, an effect of enabling efficient quality correction can be achieved while meeting a request from a designer that he or she does not want to stereoscopically display additional information such as OSD.

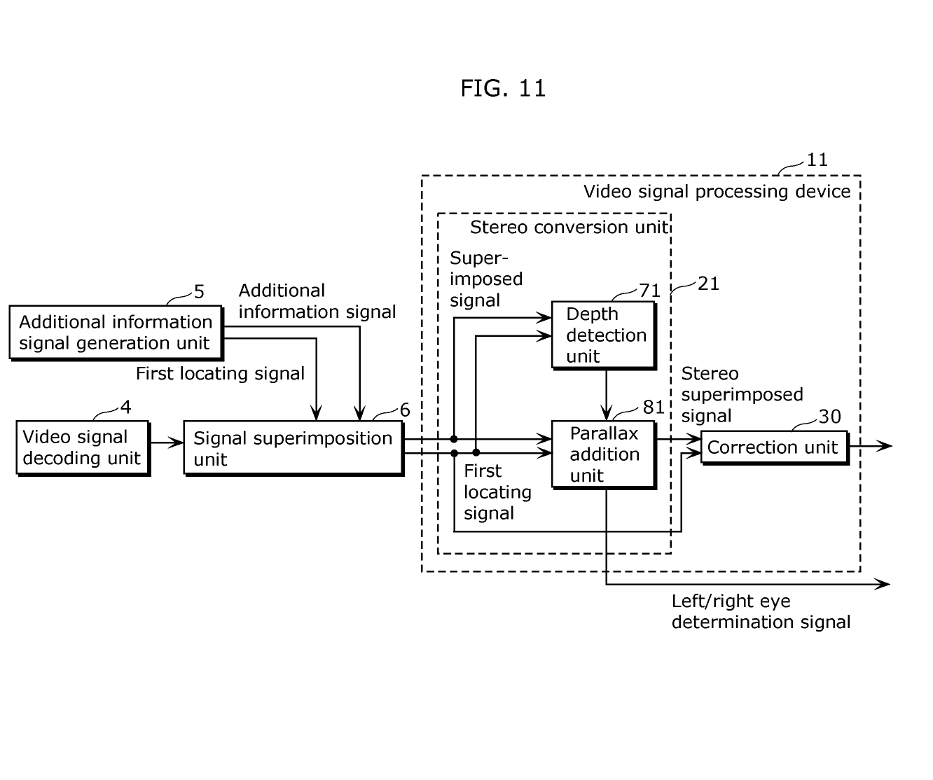

It should be noted that in the present embodiment, the parallax addition unit 80 included in the stereo conversion unit 20 performs stereo conversion using first locating signals so that parallax is not added to an area located by the first locating signals. However, the present invention is not limited to this. For example, a variation as illustrated in FIG. 11 is also possible.

FIG. 11 is a block diagram illustrating a basic configuration of a video signal processing device 11 according to a first variation of Embodiment 2.

In a stereo conversion unit 21 included in the video signal processing device 11, the depth detection unit 71 does not detect the amount of depth from an area located by first locating signals (performs detection so as to prevent the area from receding into distance or projecting toward a viewer).

A difference from the stereo conversion unit 20 in the video signal processing device 10 is that the stereo conversion unit 21 prevents a parallax addition unit 81 from adding parallax to additional information, by executing the above processing. In this manner, the video signal processing device 11 can also obtain similar operation effects as the video signal processing device 10.

Furthermore, the video signal processing device can be configured so as to switch whether or not additional information such as OSD is stereoscopically displayed, according to a viewer's preference.

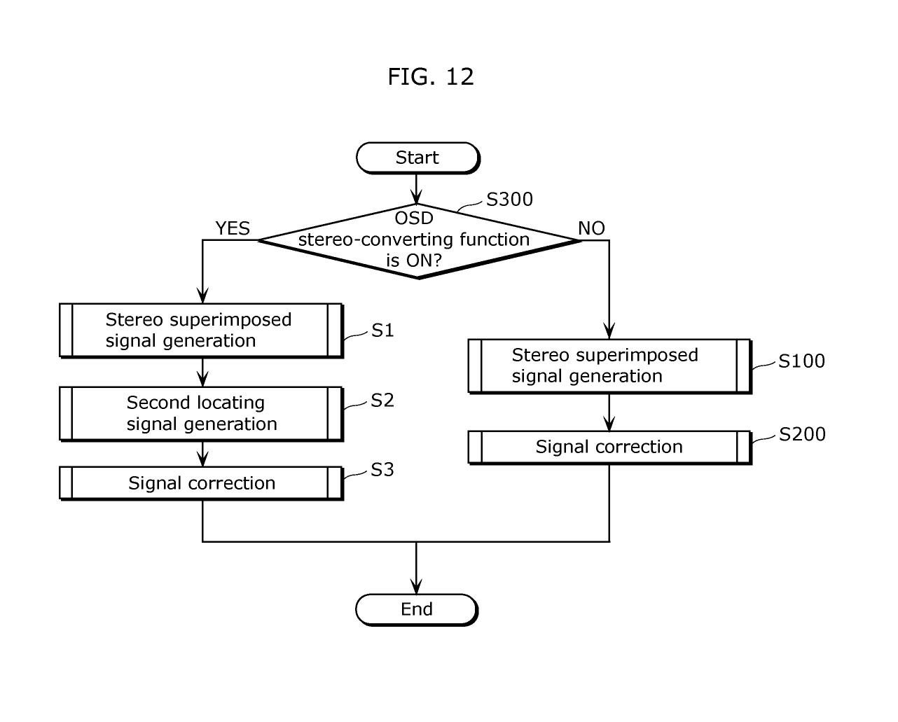

FIG. 12 is a flowchart showing a flow of video signal processing in a second variation of Embodiment 2.

The device which executes processing illustrated in FIG. 12 (device according to the second variation) determines in S300 whether a function of stereo-converting OSD or the like is ON. As a result of the determination, if the stereo conversion function is ON (YES in S300), the device according to the second variation operates as the video signal processing device 1 according to Embodiment 1, whereas if the stereo conversion function is OFF (NO in S300), the device according to the second variation operates as the video signal processing device 10 (or 11) according to Embodiment 2.

According to such processing, it is possible to switch between stereoscopically displaying and two-dimensionally displaying additional information such as OSD according to a user's (viewer's) preference, and at the same time, video signal processing is possible in which quality correction is not performed on an area in which additional information such as OSD is displayed.

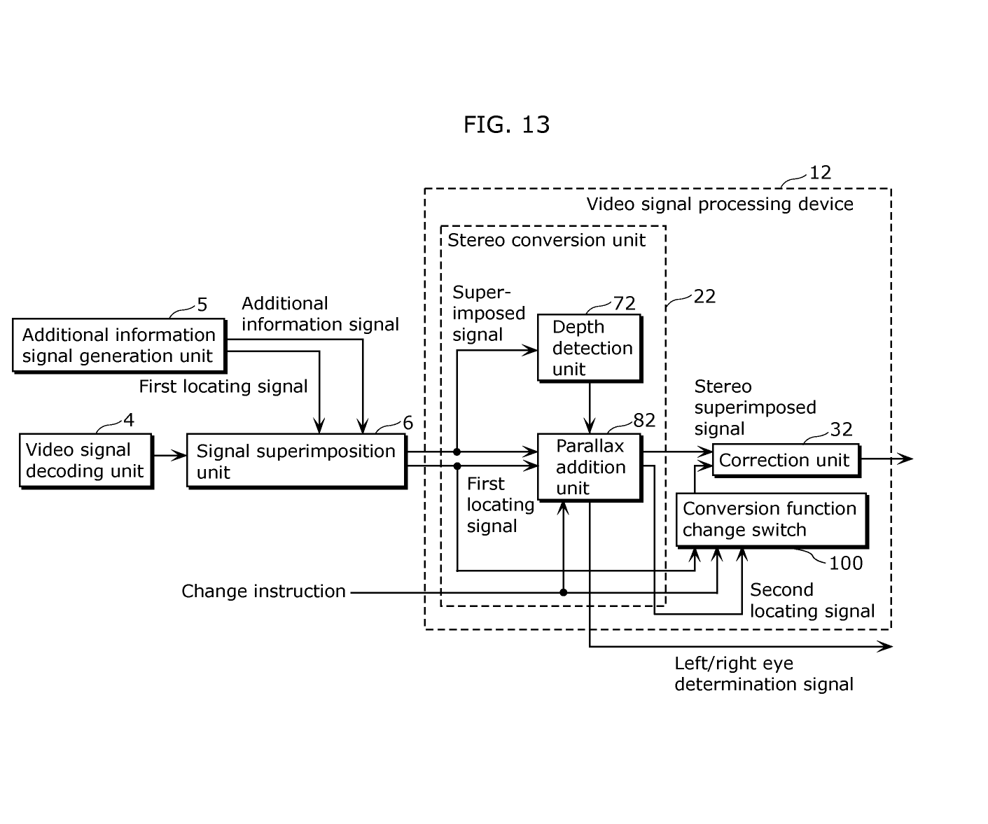

A video signal processing device 12 having a configuration illustrated in FIG. 13, for example, executes processing illustrated in FIG. 12.

FIG. 13 is a block diagram illustrating a basic configuration of the video signal processing device 12 according to the second variation of Embodiment 2.

The video signal processing device 12 includes a stereo conversion unit 22 having the depth detection unit 72 and a parallax addition unit 82, and a conversion function change switch 100, in addition to a correction unit 32.

Furthermore, the output from the conversion function change switch 100 is switched between first locating signals and second locating signals, as appropriate, in response to a switching instruction from a viewer.

Specifically, the conversion function change switch 100 outputs second locating signals to the correction unit 32 if in the state where additional information such as OSD is to be stereoscopically displayed, whereas the conversion function change switch 100 outputs first locating signals to the correction unit 32 if in the state where additional information such as OSD is not to be stereoscopically displayed.

The parallax addition unit 82 also obtains change information from the conversion function change switch 100, and outputs stereo superimposed signals obtained by stereo-converting both a two-dimensional video and additional information if the conversion function change switch 100 is in the state where additional information such as OSD is to be stereoscopically displayed.

In addition, the parallax addition unit 82 outputs stereo superimposed signals which include stereo-converted two-dimensional video signals and additional information signals which are not stereo-converted if the conversion function change switch 100 is in the state where additional information such as OSD is not to be stereoscopically displayed.

The video signal processing device 12 has such a configuration, thereby performing the processing illustrated in FIG. 12, for example.

It should be noted that although signals for locating the display position of additional information in the horizontal and vertical directions are used as first locating signals in the present embodiment, the present invention is not limited to this.

Various signals are applicable as first locating signals applied to the present invention. For example, alpha blending signals indicating the transparency of additional information such as OSD when the additional information is combined may be used as the first locating signals.

A configuration may be adopted in which a first locating signal is generated for each pixel. Specifically, as long as the position of additional information at the time when the additional information is combined with a two-dimensional video and displayed can be located, any signal may be used.

Here, in the present embodiment, FIG. 9 illustrates first locating signals for locating the display position of additional information in the vertical direction in addition to first locating signals corresponding to the horizontal direction, in order to facilitate the understanding of characteristics of the first locating signals. However, such first locating signals corresponding to the vertical direction are not necessarily needed.

Specifically, a case is assumed in which pixels move only in the horizontal direction due to the addition of parallax for stereoscopic display to a two-dimensional video. In this case, without using first locating signals corresponding to the vertical direction, the video signal processing device 10 (11, 12) can also execute various types of video signal processing described above using first locating signals for locating the display position of additional information in the horizontal direction.

### Supplementary description of Embodiments 1 and 2

In the above embodiments, superimposed signals and the like are shifted using right-eye parallax and left-eye parallax according to the amounts of depth detected by the depth detection unit 7. However, the stereo conversion unit 2 (20, 21, 22) may shift superimposed signals and the like in accordance with information other than parallax, which is inputted from the outside of the video signal processing device 1 (10, 11, 12), for example.

In addition, both a right-eye video and a left-eye video may not be generated by adding both right-eye parallax and left-eye parallax to a two-dimensional video indicated by inputted superimposed signals. For example, a two-dimensional video indicated by superimposed signals is handled as a left-eye video as it is, and a video generated by adding, to the two-dimensional video, a shift corresponding to parallax between right and left eyes may be handled as a right-eye video.

In other words, a stereo conversion method performed by the video signal processing device 1 (10, 11, 12) is not limited to a specific method. The video signal processing device 1 (10, 11, 12) can output a video obtained by performing quality correction on an area other than the display area of additional information as described above, as long as stereo conversion processing is performed which at least includes shifting two-dimensional video signals no matter what method is adopted as the stereo conversion method.

The above is a description of the video signal processing device and the video signal processing method according to the present invention based on embodiments. However, the present invention is not limited to the above embodiments. The scope of the present invention includes various modifications to the above embodiments that may be conceived by those skilled in the art or forms constructed by combining constituent elements described above, which do not depart from the essence of the present invention.

### INDUSTRIAL APPLICABILITY

The video signal processing device and the video signal processing method according to the present invention are useful as a stereoscopic video display device such as a television receiver, and a device and a method applied to a media reproduction player, for instance.

### REFERENCE SIGNS LIST

1, 10, 11, 12 Video signal processing device
2, 20, 21, 22 Stereo conversion unit
3, 30, 32 Correction unit
4 Video signal decoding unit
5 Additional information signal generation unit
6 Signal superimposition unit
7, 71, 72 Depth detection unit
8, 80, 81, 82 Parallax addition unit
100 Conversion function change switch

1. A video signal processing device comprising:
a stereo conversion unit which performs stereo conversion processing including processing of generating a stereo video signal by shifting a two-dimensional video signal indicating a two-dimensional video, the stereo conversion unit being configured to (i) generate a stereo superimposed signal by performing the stereo conversion processing on a superimposed signal obtained by superimposing, on the two-dimensional video signal, an additional information signal indicating additional information to be combined with the two-dimensional video and displayed, and
(ii) shift a first locating signal indicating a position of the additional information in the two-dimensional video, according to an amount of shift caused by the stereo conversion processing on the additional information signal, to generate a second locating signal indicating a position of the additional information in a video indicated by the stereo superimposed signal; and
a correction unit configured to perform, on the stereo superimposed signal, quality correction for an area other than an area located by the second locating signal.

2. The video signal processing device according to claim 1,
wherein when the stereo conversion unit performs the stereo conversion processing on the superimposed signal, the stereo conversion unit is configured to generate the stereo video signal from the two-dimensional video signal, shift the additional information signal to generate a stereo additional information signal indicating the additional information to be stereoscopically viewed, and generate the stereo superimposed signal which includes the stereo video signal and the stereo additional information signal.

3. The video signal processing device according to claim 2,
wherein a plurality of the first locating signals are signals each indicating whether, when the two-dimensional video combined with the additional information is displayed, one of plural pixels constituting the two-dimensional video forms a part of the additional information.

4. The video signal processing device according to claim 2,
wherein in the stereo conversion processing by the stereo conversion unit, the stereo conversion unit is configured to shift the two-dimensional video to generate the stereo video signal indicating a left-eye video obtained by adding left-eye parallax to the two-dimensional video and a right-eye video obtained by adding right-eye parallax to the two-dimensional video, and
the stereo conversion unit is configured to shift the additional information signal and the first locating signal according to one of the left-eye parallax and the right-eye parallax, to generate the stereo additional information signal and the second locating signal indicating a position of the additional information in a corresponding one of the left-eye video and the right-eye video, the additional information being indicated by the stereo additional information signal.

5. A video signal processing device comprising:
a stereo conversion unit which performs stereo conversion processing including processing of generating a stereo video signal by shifting a two-dimensional video signal indicating a two-dimensional video, the stereo conversion unit being configured to generate a stereo superimposed signal by performing, on a superimposed signal obtained by superimposing on the two-dimensional video signal an additional information signal indicating additional information to be combined with the two-dimensional video and displayed, the stereo conversion processing for an area other than an area located by a first locating signal indicating a position of the additional information in the two-dimensional video; and
a correction unit configured to perform, on the stereo superimposed signal, quality correction for the area other than the area located by the first locating signal.

6. The video signal processing device according to claim 5,
wherein a plurality of the first locating signals are signals each indicating whether, when the two-dimensional video combined with the additional information is displayed, one of plural pixels constituting the two-dimensional video forms a part of the additional information.

7. The video signal processing device according to claim
wherein when the stereo conversion unit performs the stereo conversion processing on the superimposed signal, the stereo conversion unit is configured to
(i) generate the stereo video signal from the two-dimensional video signal, shift the additional information signal to generate a stereo additional information signal indicating the additional information to be stereoscopically viewed, and generate the stereo superimposed signal which includes the stereo video signal and the stereo additional information signal, and
(ii) shift the first locating signal according to an amount of shift caused by shifting the additional information signal, to generate a second locating signal indicating a position of the additional information in a video indicated by the stereo superimposed signal,
the video signal processing device further comprises
a change switch which outputs one of the first locating signal and the second locating signal to the correction unit in accordance with an inputted instruction, and
the correction unit is configured to perform, on the stereo superimposed signal, quality correction for an area other than an area located by the one of the first locating signal and the second locating signal outputted from the change switch.

8. A video signal processing method comprising:
(a) (i) generating a stereo superimposed signal by performing, on a superimposed signal, stereo conversion processing including processing of generating a stereo video signal by shifting a two-dimensional video signal indicating a two-dimensional video, the superimposed signal being obtained by superimposing, on the two-dimensional video signal, an additional information signal indicating additional information to be combined with the two-dimensional video and displayed, and
(ii) shifting a first locating signal indicating a position of the additional information in the two-dimensional video, according to an amount of shift caused by the stereo conversion processing on the additional information signal, to generate a second locating signal indicating a position of the additional information in a video indicated by the stereo superimposed signal; and
(b) performing, on the stereo superimposed signal, quality correction for an area other than an area located by the second locating signal.

9. The video signal processing method according to claim 8,
wherein in step (a), when the stereo conversion processing is performed on the superimposed signal, the stereo video signal is generated from the two-dimensional video signal, the additional information signal is shifted to generate a stereo additional information signal indicating the additional information to be stereoscopically viewed, and the stereo superimposed signal which includes the stereo video signal and the stereo additional information signal is generated.

10. The video signal processing method according to claim 9,
wherein a plurality of the first locating signals are signals each indicating whether, when the two-dimensional video combined with the additional information is displayed, one of plural pixels constituting the two-dimensional video forms a part of the additional information.

11. The video signal processing method according to claim 9,
wherein in the stereo conversion processing in step (a), the two-dimensional video is shifted to generate the stereo video signal indicating a left-eye video obtained by adding left-eye parallax to the two-dimensional video and a right-eye video obtained by adding right-eye parallax to the two-dimensional video, and
in step (a), the additional information signal and the first locating signal are shifted according to one of the left-eye parallax and the right-eye parallax, to generate the stereo additional information signal and the second locating signal indicating a position of the additional information in a corresponding one of the left-eye video and the right-eye video, the additional information being indicated by the stereo additional information signal.
